(19) United States
(12) Patent Application Publication
(10) Pub. No.: US 2007/0115325 A1
(43) Pub. Date: May 24, 2007

(54) INK-JET INK AND INK-JET RECORDING METHOD

(75) Inventor: Yoshinori TSUBAKI, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA HOLDINGS, INC., Tokyo (JP)

(21) Appl. No.: 11/558,013

(22) Filed: Nov. 9, 2006

(30) Foreign Application Priority Data
Nov. 21, 2005 (JP) JP2005-335828

(51) Int. Cl. B41J 2/14

(52) U.S. Cl. 347/52

(57) ABSTRACT

An ink-jet is disclosed, comprising a colorant, water, a polymeric compound which is comprised of a hydrophilic backbone having plural side chains and is capable of curing via the side chains upon exposure to an actinic ray and a fluorine-containing surfactant having a specific structure. An ink-jet recording method is also disclosed.

This application claims priority from Japanese Patent Application No. JP2005-335828 filed on Nov. 21, 2005, which is incorporated hereinto by reference.

### FIELD OF THE INVENTION

The present invention relates to an ink for use in ink-jet recording and an ink-jet recording method by use thereof, and in particular to an ink-jet ink exhibiting superior recording performance and adhesion property even for polyvinyl chloride or polyethylene film which is ink-nonabsorptive and exhibits high surface energy, and an ink-jet recording method by use thereof.

### BACKGROUND OF THE INVENTION

Ink-jet recording methods enable highly precise image recording by using a relatively simple apparatus and has achieved rapid progress in various fields. The use thereof ranges widely and a recording medium or inks suitable for the individual purpose are employed.

Recently, marked enhancement of recording speed has been achieved and there have been developed printers suitable for short printing runs.

However, special ink-jet paper is needed to derive the best performance of an ink-jet printer.

Recording on coated paper or art paper which exhibits little ink-absorptivity or on plastic resin film exhibiting no absorptivity produces problems such as chromatic bleeding in which different color inks are mixed on the recording medium, easily causing color contamination, which has become a problem to be solved to enable use of a variety of recording media for ink-jet recording.

Proposed to solve the foregoing problem was an ink used for ink-jet recording, which was curable upon exposure to ultraviolet rays, as disclosed in U.S. Pat. No. 4,228,438. There was also proposed a non-aqueous ink which contained an indispensable pigment and a polyacrylate having a valence of 3 or more as a polymerizable material and also contained a ketone or an alcohol as a main solvent, as disclosed in U.S. Pat. No. 4,228,438 and JP-B No. 5-64667 (hereinafter, the term JP-B refers to Japanese Patent Publication).

There was also proposed an ink using an aqueous ultraviolet-polymerizable monomer, as disclosed in JP-A No. 7-224241 (hereinafter, the term JP-A refers to Japanese Patent Application Publication) . This ink, which was curable by a curing component, was able to record even onto a non-absorptive medium but contained a large amount of a curing component other than the colorant. This component was non-volatile so that ink dots rose on the recording surface, resulting in unnatural image quality, specifically in glossiness.

To reduce this unnaturalness, even if the curing component was reduced and replaced by a volatile organic solvent or water, the volatile organic solvent in turn produced problems of environmental concern or safety, and water could not display effects, due to insufficient sensitivity of the curing component.

Specifically, in the above-mentioned ink using an aqueous ultraviolet-polymerizable monomer, there was a problem that when recorded onto a medium having a relatively high surface energy, such as polyvinyl chloride or polyethylene terephthalate, the ink was not sufficiently wetted on the substrate and was also insufficient in adhesiveness.

Further, conventionally known curing components caused concern with respect to safety and even if safety was overcome, there were still problems that selection of materials was narrowed, rendering it difficult to freely design material or physical properties.

### SUMMARY OF THE INVENTION

Accordingly, it is an object of the present invention to provide an ink-jet ink achieving high image quality without forming unnatural glossiness even when recorded onto the substrate exhibiting a relatively high surface energy and an ink-jet recording method by use thereof.

One aspect of the invention is directed to an ink-jet ink comprising a colorant, water, a polymeric compound which is comprised of a hydrophilic backbone chain having plural side chains and is capable of curing (or cross-linking) via the side chains upon exposure to an actinic ray and a fluorine-containing surfactant represented by the following formulas [1] to [3]:
Rf-(L₁)ₘ(Y₁)ₙ—X formula [1]
wherein Rf represents an aliphatic group containing at least one fluorine atom; L₁ represents a divalent linkage group; Y₁ represents an alkyleneoxy or alkylene group which may be substituted; X represents a hydrogen atom, hydroxyl group, an anionic group or a cationic group; m represents 0 or an integer of 1 to 5 and n represents 0 or an integer of 1 to 40,
Rf—(OI—Rf′)ₙ₁-L₂-X′ₘ₁ formula [2]
wherein Rf represents an aliphatic group containing at least one fluorine atom; Rf′ represents an alkylene group containing at least one fluorine atom; L₂ represents a single bond or a linkage group; X′ represents hydroxyl group, an anionic group or a cationic group; n1 and m1 each represent an integer of 1 or more,
[(Rf″O)ₙ₂—(PFC)—CO—Y₂]_{k -L}₃-X″ₘ₂ formula [3]
wherein Rf″ represents a perfluoroalkyl group having 1 to 4 carbon atoms; designation PFC represents a perfluorocycloalkylene group; Y₂ represents a linkage group containing an oxygen atom or a nitrogen atom; L₃ represents a single bond or a linkage group; X″ represents a water-solubilizing polar group containing an anionic group, a cationic group, a nonionic group or an amphoteric group; n2 represents an integer of 1 to 5, k represents an integer of 1 to 3 and m2 represents an integer of 1 to 5.

Another aspect of the invention is directed to an ink-jet recording method by using the ink-jet ink described above, wherein the ink is ejected from an ink jet head, the ejected ink is exposed to an actinic ray and subsequently dried.

### DETAILED DESCRIPTION OF THE INVENTION

The polymeric compound of the invention, which is comprised of a hydrophilic backbone chain (which is hereinafter denoted as hydrophilic backbone) having plural side chains and is capable of curing via the side chains (which is hereinafter also denoted as an actinic energy ray-curable polymeric compound) is a hydrophilic resin selected from the group of a saponified polyvinyl acetate, polyvinyl acetal, polyethylene oxide, polyalkylene oxide, polyvinyl pyrrolidone, polyacrylamide, polyacrylic acid, hydroxyethyl cellulose, methyl cellulose, hydroxypropyl cellulose, derivatives of the foregoing hydrophilic resins and their copolymers, in which at least one modifying group, such as a photo-dimerizable group, a photo-degradable group, a photo-polymerizable group, a photo-modifying group or a photo-depolymerizable group. Of these modifying groups, a photo-polymerizable group (or photo-curable group, i.e., a group capable of curing or crosslinking through photopolymerization upon exposure to an actinic ray) is preferred in terms of performance of the formed image.

A preferred combination exists between ionicity of a colorant and ionicity of the side chains of the polymeric compound. It was proved that the combination of an anionic colorant with nonionic or anionic side chains resulted in superiority in image fastness, storage stability and continuous ejectability of the ink. Anionic side chains are specifically preferred. The reason therefor is not clear but it is assumed that the foregoing ionic combination results in reduction in decomposition or association of the ink composition, possibly leading to advantageous effects, as described above.

The structure of a hydrophilic backbone and a side chain of the actinic ray curing polymeric compound of the invention is represented preferably by the following formula (A):
Poly-{(X₁)ₘ-[B—(Y₁)ₙ]ₚ} formula (A)

In the formula (A), designation “Poly” represents a hydrophilic backbone and is preferably a saponified polyvinyl acetate, polyvinyl acetal, polyalkylene oxide including a polyethylene oxide, polyvinyl pyrrolidone, polyacrylamide, polyacrylic acid, hydroxyethyl cellulose, methyl cellulose, hydroxypropyl cellulose, derivatives of the foregoing resins and their copolymers.

The designation, {(X)ₘ-[B—(Y₁)ₙ]ₚ} represents side chains. In the side chains, X₁ represents a (p+1)-valent linkage group, m is 0 or 1, and “p” represents an integer and preferably an integer of 1 to 5. Specifically, when p is 1, X₁ is a divalent linkage group and examples thereof include an alkylene group, an arylene group, a heteroarylene group, an ether group, a thioether group, an imino group, an ester group, an amide group, and a sulfonyl group, provided that these groups may be combined with each other to form a di- or more valent group. When p is 2 or more, plural Bs or Y₁s may be the same or different. X₁ is preferably an alkyleneoxy group or a di- or more valent linkage group combined with an aromatic group.

B represents a curing group and specifically a group containing a double bond or a triple bond. Examples thereof include an acryl group, a methacryl group, a vinyl group, an allyl group, a diazo group, and an azido group. Of these, an acryl group or a methacryl group is preferred.

Y₁ represents a hydrogen atom or a substituent. Specific examples of a substituent include a halogen atom (e.g., fluorine atom, chlorine atom), an alkyl group (e.g., methyl, ethyl butyl, pentyl, 2-methoxyethyl, trifluoromethyl, 2-ethylhexyl, cyclohexyl), an aryl group (e.g., phenyl, p-tolyl, naphthyl), an acyl group (e.g., acetyl propionyl, benzoyl), an alkoxy group (e.g., methoxy, ethoxy, butoxy), an alkoxycarbonyl group (e.g., methoxycarbonyl, 1-propoxycarbonyl), an acyloxy group (e.g., acetyloxy, ethylcarbonyloxy), a carbamoyl group (e.g., methylcarbamoyl, ethylcarbamoyl, butylcarbamoyl, phenylcarbamoyl), a sulfamoyl group (e.g., sulfamoyl, methylsulfamoyldimethylsulfamoyl, phenylsulfamoyl), an alkylthio group (e.g., methylthio, ethylthio, octylthio), an arylthio group (e.g., phenylthio, p-tolythio), an alkylureido group (e.g., methylureido. ethylureido, methoxyureido, dimethylureido), an arylureido group (e.g., phenylureido), an alkylsulfonamido group (e.g., methanesulfonamide, ethanesulfonamido, butanesulfonamide trifluoromethylsulfonamide, 2,2,2-trifluoroethylsulfonamido), an arylsulfonamido group (e.g., phenylsulfonamide, tolylsulfonamido), an alkylaminosulfonylamino group (e.g., methylaminosulfonylamino, ethylaminosulfonylamino), an arylaminosulfonylamino group (e.g., phenylaminosulfonylamino), hydroxyl group, and a heterocyclic group (e.g., pyridyl, pyrazolyl, imidazolyl, furyl, thienyl). These groups may be substituted.

In the formula, m is 0 or 1, and n is 0 or 1.

The hydrophilic backbone is preferably a saponified polyvinyl acetate in term of easiness of introducing the side chains and handling. The saponified polyvinyl acetate preferably exhibits a polymerization degree of 200 to 1700 (more preferably 500 to 1200) and a saponification degree of 77% to 99% in terms of handling. The saponified polyvinyl acetate, which is also called polyvinyl alcohol, is represented as below:

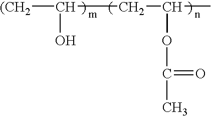

Polymerization degree: m+n

Saponification degree: [m/(m+n)]×100(%)

where m+n represents a polymerization degree, while [m/(m+n)]×100 represents a saponification degree.

Preferably, the saponified polyvinyl acetate is modified by introducing side chains as a modifying group, which is therefore also denoted as a modified polyvinyl alcohol. Such a modified, saponified polyvinyl acetate (or modified polyvinyl alcohol) preferably exhibits a modification ratio of the side chains to the backbone of 0.5 to 4 mol % and more preferably from 0.5 to 1.5 mol % in terms of reactivity. A modification ratio of less than 0.5 mol % results in insufficient curing, leading to reduced targetted effects of the invention. A modification ratio of more than 4 mol % results in excessively increased curing density and formation of a brittle film, leading to decreased film strength. The modification ratio of the side chains to the backbone is defined as a molar ratio (expressed in mol %) of the side chain introduced to the hydrophilic backbone, which is illustrated as above by —[CH₂—CH(OH)]ₘ—.

Of the actinic ray curing polymeric compounds of the invention, a light-sensitive resin described in JP-A No. 56-67309 is cited as a further preferred structure. The light-sensitive resin composition described in JP-A No. 56-67309 is a resin composition having a side chain of a 2-azido-5-nitrophenylcarbonyloxyethylene structure (which is anionic) represented by the following formula (1) or a side chain of 4-azido-3-nitrophenylcarbonyloxyethylene structure (which is nonionic) represented by the following formula (2):

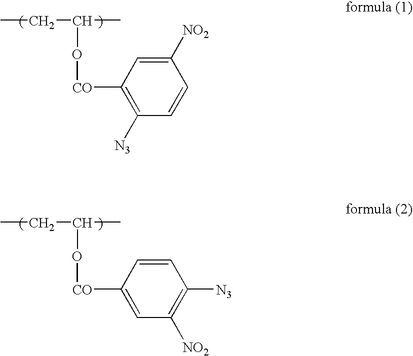

Further, a side chain of a modifying group (anionic), represented by the following formula (3) is also preferred: 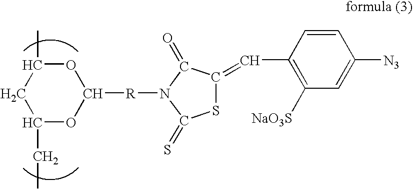
wherein R is an alkylene group or an aromatic ring, and preferably a benzene ring.

A (nonionic) resin described in JP-A Nos. 2000-181062 and 2004-189841, represented by the following formula (4) is also preferred as a photopolymerizable modifying group, in terms of reactivity: 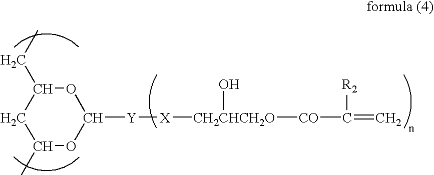
wherein R₂ represents —CH₃ (methyl) or H; n is 1 or 2; X represents —(CH₂)ₘ—COO— or —O—; Y represents an aromatic ring or a single bond; and m is an integer of 0 to 6.

A (nonionic) photopolymerizable modifying group described in JP-A No. 2004-161942, represented by the following formula (5) is preferably usable in conventionally known water-soluble resin: 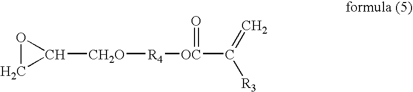
wherein R₃ represents methyl (—CH₃) or H; and R₄ represents a straight chain or branched alkylene group.

Modifying groups (nonionic) represented by the following formulas (6) to (8) are also preferred:

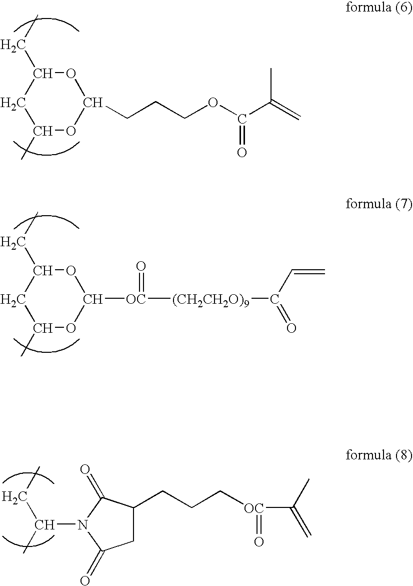

Such an actinic ray-crosslinking resin is contained preferably in an amount of 0.5% to 5.0% by weight, based on the total amount of the ink. A content of 0.5% or more results in enhanced crosslinking efficiency and a rapid increase of an ink viscosity after crosslinking leads to an improvement in beading or color-bleeding. A content of not more than 5.0% by weight, which renders it difficult to adversely affect physical properties of the ink or the state of the interior of an ink head, is preferred in terms of ejectability and storage stability of the ink.

In the actinic ray curing type resin of the invention, the backbones having a certain degree of polymerization is further crosslinked through crosslinking between side chains, leading to a marked increase in molecular weight per photon, as compared to an actinic ray curing type resin which is formed by polymerization via conventional chain reaction. In commonly known actinic ray crosslinking resins, control of the number of crosslinking points is not feasible so that physical properties of cured film are uncontrollable, resulting in formation of fragile hard film. On the contrary, in the resin of the invention, the number of crosslinking points can be controlled by the length of the hydrophilic backbone and introduction of side chains, rendering it feasible to control physical properties of the ink membrane corresponding to the object of the invention.

In a commonly known actinic ray curing type ink, most of the content of the ink is accounted for by curing components except for the colorant, causing cured ink dots to rise, leading to inferior image quality, for instance, in glossiness. On the contrary, the resin of the invention can be used at the relatively small amount necessary to form a dot-image and evaporative components account for a large content, achieving superior fixability and enhanced image quality after being dried.

In one preferred embodiment of the invention, there are employed photopolymerization initiators or photosensitizers. These compounds may be dissolved or dispersed in solvents, or may be chemically bonded to a photosensitive resin.

Applicable photopolymerization initiators and photosensitizers are not specifically limited but commonly known ones are usable, and water-soluble compounds are preferable in terms of miscibility and reaction efficiency. Specifically, 4-(2-hydroxyethoxy) phenyl-(2-hydroxy-2-propyl)ketone (or HMPK), thioxanthon ammonium salt (or QTX) and benzophenone ammonium salt (or ABQ) are preferred in terms of miscibility with aqueous solvents.

Further, compounds represented by the following formula (9), specifically 4-(2-hydroxyethoxy)phenyl-(2-hydroxy-2-propyl)ketone (n=1, HMPK) and its ethylene oxide adduct (n=2-5) are more preferred: 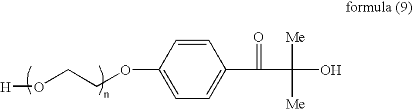
wherein n is an integer of 1 to 5.

Furthermore, examples of other preferred photopolymerization initiators include benzophenones such as hydroxybenzophenone, bis-N,N-dimethylaminobenzophenone, bis-N,N-diethylaminobenzophenone and 4-methoxy-4′-dimethylaminobenzophenone; thioxanthones such as thioxanthone, 2,4-diethylthioxantone, isopropylthioxantone, chlorothioxanthone and isopropoxychlorothioxanthone; anthraquinones such as ethylanthraquinone, aminoanthraquinone, and chloroanthraquinone; acetophenones; benzoin ethers such as benzoin methyl ether; 2,4,6-trihalomethyltriazines; 1-hydroxycyclohexylphenyl ketone; 2,4,5-triarylimidazole dimmers such as 2-(o-chlorophenyl)-4,5-diphenylimidazole dimmer, 2-(o-chlorophenyl)-4,5-di-(m-methoxyphenyl)imidazole dimmer, 2-(o-fluorophenyl)-4,5-diphenylimidazole dimmer, 2-(o-methoxyphenyl)-4,5-diphenylimidazole dimmer, 2-(p-methoxyphenyl)-4,5-diphenylimidazole dimmer, 2-di(p-methoxyphenyl)-5-phenylimidazole dimmer and 2-(2,4-dimethoxyphenyl)-4,5-diphenylimidazole dimmer; benzyl dimethyl ketal, 2-2-benzyl-2-dimethylamino-1-(4-morpholinophenyl)butane-1-one, 2-methyl-1-[4-(methylthio)phenyl]-2-morpholino-1-propane, 2-hydroxy2-methyl-1-phenyl-propane-1-one, 1-[4-(2-hydroxyethoxy)-phenyl]-2-hydroxy-2-methyl-propane-1-one, phenanthrene, 9,10-phenthrenequinone; benzoins such as methylbenzoin and ethylbenzoin; acridine derivatives such as 9-phenylacridine and 1,7-bis(9,9′-acridinyl)heptane; bisacylphosphine oxide; and mixtures of the foregoing compounds. These compounds may be used alone or in combination.

In addition to these photopolymerization initiators, accelerators may be incorporated. Examples thereof include ethyl p-dimethylaminobenzoate, isoamyl p-dimethylaminobenzoate, ethanolamine, diethanolamine and triethanolamine.

Of the foregoing photopolymerization initiators, those which are comprised of a hydrophilic backbone grafted by side chains, are also preferred.

The actinic energy rays of the invention include, for example, an electron beam, an ultraviolet ray, α-ray, β-ray, γ-ray, and X-rays. Of these, an electron beam and an ultraviolet ray are preferable in terms of human safety, ease of handling and industrial availability.

When exposed to an electron beam, the dosage of the exposed electron beam is desirably within the range of 0.1 to 30 Mrad. A dosage of less than 0.1 Mrad cannot effectuate sufficient exposure and a dosage of more than 30 Mrad possibly deteriorates the support.

When exposed to ultraviolet rays, commonly known light sources are used, such as low-pressure, medium-pressure and high-pressure mercury lamps having an operation pressure within the range of 0.1 kPa to 1 MPa, metal halide lamps, xenon lamps exhibiting emission within the ultraviolet wavelength region, cold cathodes tube and thermal cathode tubes and LED.

Exposure to an actinic ray is preferably within the range of 0.001 to 1.0 sec and more preferably 0.001 to 0.5 sec. after being ink-deposited. It is essential for precise image formation that exposure timing is as soon as possible.

A basic method for exposure of actinic rays is disclosed in JP-A No. 60-132767. Specifically, light sources are provided on both sides of a head unit, and the head and the light sources are made to scan through a shuttle system. Exposure is performed at an interval after ink deposition. Curing is completed by another undriven light source. U.S. Pat. No. 6,45,979 discloses an exposure method using an optical fiber and an exposure method in which collimated light strikes the mirror surface provided on the side a head unit, thereby exposing a printed section to UV light. Either of the foregoing methods are applicable to the image forming method of the invention.

In one preferred embodiment, exposure to an actinic ray is separated into two stages. Exposure to an actinic ray is conducted within 0.001 to 2.0 sec after ink deposition, followed by exposure to an actinic ray. Separation of exposure to two stages can prevent shrinkage of recording material which tends to occur in the ink curing stage.

The ink-jet ink containing an actinic ray curing polymeric compound of the invention contains a fluorinated surfactant represented by the following formulas (1) to (3):
Rf-(L₁)ₘ(Y₁)ₙ—X formula [I]
wherein Rf is an aliphatic group containing at least one fluorine atom; L₁ is a divalent linking group; Y₁ is an alkyleneoxy or alkylene group, which may be substituted; X is a hydrogen atom, hydroxyl group, an anionic group or a cationic group; m is an integer of 1 to 5; and n is an integer of 1 to 40;
Rf—(O—Rf′)ₙ₁-L₂-X′ₘ₁ formula {II}
wherein Rf is an aliphatic group containing at least one fluorine atom; Rf′ is an alkylene group containing at least one fluorine atom; L₂ is a single bond or a linking group; X′ is hydroxyl group, an anionic group or a cationic group; and n1 and m1 are each an integer of 1 or more;
[(Rf″O)—(PFC)—CO—Y₂]ₖ-L₃-X″ₘ₂ formula (3)
wherein Rf″ is a perfluoroalkyl group having 1 to 4 carbon atoms: (PFC) is a perfluorocycloalkylene group; Y₂ is a linking group containing an oxygen atom or nitrogen atom; L₃ is a single bond or a linking group; X″ a water-solubilizing polar group containing an anionic group, a cationic group, a nonionic group or an amphoteric group; n2 is an integer of 1 to 5, k is an integer of 1 to 3, and m2 is an integer of 1 to 5.

In the foregoing formulas [1] and [2], Rf represents an aliphatic group containing at least one fluorine atom and the aliphatic group preferably has 1 to 18 carbon atoms, more preferably 2 to 12 carbon atom, and still more preferably 3 to 7 carbon atoms.

In the formula [1], L₁ represents a divalent linking group. Examples of a preferred divalent linking group include a sulfonamide group, an alkyleneoxy group, a phenoxy group and an alkylenecarbonyl group.

In the formula [1], Y₁ is an alkyleneoxy group or an alkylene group, which may be substituted. Examples of an alkyleneoxy group include an ethyleneoxy group and an propyleneoxy group, and an ethyleneoxy group is preferred. Alkylene groups include, for example, a methylene group, ethylene group and propylene group, and an ethylene group is preferred.

In the formula [1], X represents a hydrogen atom, hydroxy group, an anionic group or a cationic group. Preferred examples of an anionic group include a carboxyl group, a sulfonic acid group and a phosphoric acid group. A counter ion of the anionic group is preferably an alkali metal ion such as sodium ion or potassium ion and an ammonium ion. A cationic group is preferably a quaternary alkylammonium group. A counter ion of the cationic group is preferably a halide ion or p-toluenesulfonic acid ion.

In the formula [1], m is 0 or an integer of 1 to 5; n is 0 or an integer of 1 to 40, and preferably, m is 0 and n is an integer of 10 to 20.

In the formula [2], Rf′ represents an alkylene group containing at least one fluorine atom, preferably having 1 to 8 carbon atoms, more preferably 2 to 5 carbon atoms and still more preferably 2 or 3 carbon atoms.

In the formula [2], L₂ represents a single bond or a linking group. The linking group is preferably an alkylene group, an arylene group or a heteroatom-containing divalent group.

In the formula [2], X′ represents hydroxyl group, an anionic group or a cationic group. The anionic group is preferably a carboxyl group, sulfonic group or phosphoric acid group. A counter ion of the anionic group is preferably an alkali metal ion such as sodium ion or potassium ion, or ammonium ion. The cationic ion is preferably a quaternary alkylammonium ion and a counter ion of the cationic group is preferably a halide ion or p-toluenesulfonic acid group.

In the formula [2], n1 and m1 are each an integer of 1 or more, and n1 is preferably an integer of 1 to 10 and ml is preferably an integer of 1 to 3.

In the formula [3], Rf″ represents a perfluoroalkyl group having 1 to 4 carbon atoms and is preferably trifluoromethyl group.

In the formula [3], PFC represents a perfluorocycloalkylene group. Examples of the perfluorocycloalkylene group include perfluorocyclooctylene, perfluorocycloheptylene, perfluorocyclohexylene and perfluorocyclopentylene, and perfluorocyclohexylene is specifically preferred.

In the formula [3], Y₂ represents a linking group containing an oxygen atom or a nitrogen atom and such a linking group is preferably —OCH₂— and —NHCH₂—.

In the formula [3], L₃ represents a single bond or a linking group. Examples of the linking group include polyvalent, generally divalent linking groups such as a substituted or unsubstituted alkylene (e.g., ethylene, n-propylene, isobutylene), arylene (e.g., phenylene), a combination of alkylene and arylene (e.g., xylilene), oxydialkylene (e.g., CH₂CH₂OCH₂CH₂) and thiodialkylene (e.g., CH₂CH₂SCH₂CH₂).

In the formula [3], X″ represents an anionic group, a cationic group, a nonionic group or a amphoteric group. Examples of a anionic group include CO₂H, CO₂M, SO₃H, SO₃M, OSO₃H, OSO₃M, (OCH₂CH₂)OSO₃M, OPO(OH)₂, and OPO(OM)₂ (in which M is a metal ion such as sodium ion, potassium ion, calcium ion, or ammonium ion) . Of these, a carboxyl group, sulfonic acid group or phosphoric acid group is preferred. A counter ion of the anionic group is preferably an alkali metal ion such as sodium ion or potassium ion, or ammonium ion. The cationic group is preferably a quaternary alkylammonium ion and a counter ion of the cationic group is preferably a halide ion or p-toluenesulfonic acid ion. The nonionic group is preferably hydroxy group.

In the formula [3], n2 is an integer of 1 to 5, k is an integer of 1 to 3, m2 is an integer of 1 to 5, n2 is preferably 3 and k is preferably 1 or 2, and m2 is preferably 1.

Specific examples of fluorinated surfactants usable in the invention are shown below but are by no means limited to these examples.

Examples of fluorinated surfactant of formula [1]:

1-1 C₈F₁₇SO₃K
1-2 C₈F₁₇SO₃Li
1-3 C₈F₇COONH₄
1-4 C₈F₁₇COOK
1-5 C₉F₁₉—O—C₆H₄SO₃K
1-6 C₉F₁₉—O—C₆H₄SO₃Na
1-7 C₆F₁₃—O—C₆H₄SO₃K
1-8 C₆F₁₃—O—C₆H₄SO₃Na
1-9 C₇F₁₅COONH₄
1-10 NaO₃S(CH(CHCOOCH₂CH₂C₈F₁₇)COOCH₂CH₂F₁₇)
1-11 C₈F₁₇SO₂N(C₃H₇) (CH₂COOK)
1-12 C₈F₁₇SO₂N(C₃H₇) (CH₂CH₂OPO₃Na₂)
1-13 C₈F₁₇SO₂N(C₁₂H₂₅) ((C₂H₄O)₄C₄H₈SO₃Na)
1-14 C₆F₁₃CH₂CH₂SO₃NH₄
1-15 CF₃CF₂(CF₂CF₂)₃CH₂CH₂SO₃NH₄
1-16 CF₃CF₂(CF₂CF₂)₄CH₂CH₂SO₃NH₄
1-17 C₆F₁₃CH₂CH₂O—PO (ONH₄)₂
1-18 C₆F₃CH₂CH₂O—PO(ONH₄) (OCH₂CH₂OH)
1-19 C₂F₅(CH₂)₆SO₃NH₄
1-20 C₃F₇(CH₂)₅SO₃NH₄
1-21 C₂F₅(CH₂)₆COOLi
1-22 C₃F₇(CH₂)₃O—C₆H₄—SO₃K
1-23 NaO₃S(CH(CHCOO(CH₂)₉C₃F₇)COO(CH₂)₉C₃F₇)
1-24 C₃F₇(CH₂)₅SO₂N(C₃H₇)(CH₂COOK)
1-25 C₃F₇(CH₂)₅SO₂N (C₁₂H₂₅) ((C₂H₄O)₄C₄H₈SO₃Na)
1-26 (C₂F₅CH₂O)₂PO(OH)₂1-27.C₃F₇CH₂CH₂OPO(OH)₂
1-28 C₃F₇CH₂CH₂SCH₂CH₂COOLi
1-29 C₆F₁₃CH₂CH₂SCH₂CH₂COOLi
1-30 (CF₁₃CH₂CH₂O)₂PO (OH)₂
1-31 C₆F₁₃CH₂CH₂O—(CH₂CH₂O)₁₀—H
1-32 C₈F₁₇CH₂CH₂O—(CH₂CH₂O)₁₂—H
1-33 C₁₀F₂₁CH₂CH₂O—(CH₂CH₂O)₈—H
1-34 C₄F₉CH₂CH₂O—(CH₂CH₂O)₂₀—H
1-35 C₃F₇CH₂CH₂O—(CH₂CH₂O)₁₀—H
1-36 C₃F₇CH₂CH₂O—(CH₂CH₂O)₁₂—H
1-37 C₂F₅CH₂CH₂O—(CH₂CH₂O)₁₅—H
1-38 C₃F₇—(CH₂CH₂O)₂—(CH₂C(OH)H—CH₂O)₁₀—H
1-39 C₄F₉—CH(CH₃) CH₂O—(CH₂CH₂O)₉—H
1-40 C₆F₁₃—(CH₂CH₂O)₃—(CH₂C(OH)H—CH₂O)₁₂—H
1-41 C₃F₇CH₂CH₂O—(CH₂CH₂O)₃₁—H
   Examples of fluorinated surfactant of formula [2]:
2-1 C₅F₁₁(OCF₂)OPO(ONa)₂
2-2 HC₆F₁₂(OCF₂)OPO(ONa)₂
2-3 C₈F₁₇(OCF₂)OPO(ONa)₂
2-4 C₁₀F₂₁(OCF₂)OPO(ONa)₂
2-5 C₁₂F₂₅(O—CF₂)OPO(ONa)₂
2-6 C₃F₇(OC₂F₄)OPO(ONa)₂
2-7 C₄F₉(OC₂F₄)OPO(ONa)₂
2-8 C₅F₁₁OC₂F₄)OPO(ONa)₂
2-9 H—C₆F₁₂—(OC₂F₄)—OPO(ONa)₂
2-10 C₇F₇F₁₅(OC₂F₄)OPO(ONa)₂
2-11 C₉F₁₉(OC₂F₄)OPO(ONa)₂
2-12 C₁₁F₂₃(OC₂F₄)OPO(ONa)₂
2-13 C₃F₇(OCF₂)₆OPO(ONa)₂
2-14 C₄F₉(OCF₂)₆OPO(ONa)₂
2-15 C₅F₁₁—(O—CF₂)₅—O—PO(ONa)₂
2-16 H—C₆F₁₂—(OCF₂)₃OPO(ONa)₂
2-17 C₃F₇O(CF₂)₃COONa
2-18 C₄F₉O(CF₂)₃COONa
2-19 C₅F₁₁O(CF₂)₃COONa
2-20 H—C₇F₁₄—[O(CF₂)₃]—OCH(COONa)₂
2-21 C₈F₁₇O(CF₂)₃OCH(COONa)₂
2-22 C₃F₇O(CF₂)₅COONa
2-23 C₄F₉O(CF₂)₅COONa
2-24 C₅F₁₁O(CF₂)₅COONa
2-25 C₇F₁₅O(CF₂)₅COONa
2-26 C₃F₇(OC₂F₄)₅COONa
2-27 C₄F₉(OC₂F₄)₂COONa
2-28 C₅F₁₁—(O—C₂F₄)₂—COONa
2-29 H—C₇F₁₄(OC₂F₄)₂COONa
2-30 C₉F₁₉(OC₂F₄)₂COONa
2-31 C₂F₅(OC₂F₄)₃COONa
2-32 C₂F₅(OC₂F₄)₅COONa
2-33 C₃F₇(OC₂F₄)₄COONa
2-34 C₄F₉(OC₂F₄)₃COONa
2-35 C₅F₁₁(OC₂F₄)₃NHCOCH(COONa)₂
2-36 H—C₆F₁₂(OC₂F₄)₃NHCOCH(COONa)₂
2-37 C₄F₉(OC₂F₄)₂OCF₂COONa
2-38 C₅F₁₁(OC₂F₄)₂OCF₂COONa
2-39 C₇F₁₅(OC₂F₄)₂OCF₂COONa
2-40 C₄F₉—OCF₂—[O(CF₂)]—COOK
2-41 C₅F₁₁—OCF₂—[O(CF₂)]—COOK
2-42 H—C₆F₁₂—OCF₂—[O(CF₂)]—COOK
2-43 C₄F₉—(OC₂F₄)₅—[O(CF₂)₃]—COOK
2-44 C₅F_{13 (OC}₂F₄)₂—[O(CF₂)₃]—COOK
2-45 C₆F₁₃—(OC₂F₄)₂—[O—(CF₂)₃]—COOK
2-46 C₁₂F₂₅OCF₂OSO₃Na
2-47 C₇F₁₅OC₂F₄OC₃H₆SO₃Na
2-48 C₄F₉—(OCF₂)₆—OSO₃Na
2-49 H—C₅F₁₀—(OCF₂)₅—OC₃H₆SO₃Na
2-50 H—C₆F₁₂—(OCF₂)₃—OSO₃Na
2-51 C₅F₁₁—(OC₂F₄)₂—OC₃H₆SO₃Na
2-52 C₇F₁₅—(OC₂F₄)₂—OSO₃Na
2-53 C₃F₇—(OC₂F₄)₄—OC₃H₆—SO₃Na
2-54 C₄F₉—(OC₂F₄)₃—O—SO₃Na
2-55 H—C₅F₁₀—(OC₂F₄)₃—OC₃H₆—SO₃Na
2-56 C₅F₁₁OCF₂—[O(CF₂)]—OSO₃Na
2-57 C₄F₉—(OC₂F₄)₂—[O (CF₂)₃]—OSO₃Na
2-58 (HCF₂)₃C—(OC₂F₄)₃—OSO₃Na
2-59 (CF₃)₂CFCF₂CF₂—(OCF₂)₅—OC₃H₆—SO₃Na
2-60 C₁₁F₂₃(OC₂F₄)OSO₃Na
2-61 C₄F₉—(OC₂F₄)₃—NHCO—(CH₂)₃—N⁺(CH₃)₃.Br⁻
2-62 C₅F₁₁—(OC₂F₄)₂—NHCO—(CH₂)₃—N^{+(CH}₃)₃.Br⁻
2-63 HC₆F₁₂—(OC₂F₄)₂—NHCO—(CH₂)₃—N⁺(CH₃)₃.Br⁻
2-64 C₄F₉—(OC₂F₄)₃—OCH₂—N⁺(CH₃)₂(C₂H₄OH).Br⁻
2-65 C₅F₁₁—(OC₂F₄)₂—OCH₂—N⁺(CH₃)₂(C₂H₄OH).Br⁻
2-66 HC₆F₁₂—(OC₂F₄)₂—OCH₂—N⁺(CH₃)₂(C₂H₄OH).Br⁻
2-67 C₅F₁₁—OCF₂—(OC₂F₄)—NHCO—(CH₂)₃—N⁺(CH₃)₃.Br⁻
2-68 (CF₃)₃C—(OC₂F₄)₃—OCH₂—N⁺(CH₃)₂(C₂H₄OH).Br⁻
2-69 C₁₂F₂₅OCF₂OH
2-70 C₇F₁₅OC₂F₄OH
2-71 C₄F₉—(OCF₂)₆—OC₃H₆OH
2-72 C₅F₁₁—(OCF₂)₅—OC₃H₆OH
2-73 HC₆F₁₂—(OCF₂)₃—OH
2-74 C₅F₁₁—(OC₂F₄)₂—OC₃H₆OH
2-75 C₇F₁₅—(OC₂F₄)₂—OC₃H₆OH
2-76 C₃F₇—(OC₂F₄)₄—OC₃H₆OH
2-77 HC₄F₈—(OC₂F₄)₃—OC(C₂H₄OH)₃
2-78 C₅F₁₁—(OC₂F₄)₃—OCH₆OH
2-79 C₅F₁₁OCF₂O(CF₂)₅OH
2-80 C₄F₉—(OC₂F₄)₂—O(CF₂)₃OH
2-81 (CF₃)₃C—(OC₂F₄)₃—OH
2-82 (HCF₂)₂CFCF₂CF₂—(OCF₂)₅—OH
2-83 C₁₁F₂₃(OC₂F₄)₄OH
   Synthesis of the foregoing compounds represented by formula [2] is disclosed in published Japanese translation of PCT international patent application Nos. 10-500950 and 11-504360.
   Examples of fluorinated surfactant of formula [3]:
3-1 (CF₃O)₃—(PFC)—CONHC₃H₆N⁺(CH₃)₂C₂H₄COO⁻
3-2 (CF₃O)₃—(PFC)—CONHC₃H₆N⁺(CH₃)₂C₂H₄SO₃⁻
3-3 (CF₃O)—(PFC)—CONHC₃H₆N⁺(CH₃)₂C₂H₄SO₃⁻
3-4 (CF₃O)₃—(PFC)—CON(C₃H₆SO₃⁻)C₃H₆N⁺(CH₃)₂H
3-5 (CF₃O)—(PFC)—CON(C₃H₆SO₃⁻)C₃H₆N⁺(CH₃)₂H
3-6 [(CF₃O)₃—(PFC)—COOCH₂]₂CH—CONHC₃H₆N⁺(CH₃)₂C₂H₄SO₃⁻
3-7 [(CF₃O)₂—(PFC)—COOCH₂]₂CH—CONHC₃H₆N⁺(CH₃)₂C₂H₄SO₃⁻
3-8 [(CF₃O)—(PFC)—COOCH₂]₂CH—CONHC₃H₆N⁺(CH₃)₂C₂H₄SO₃⁻
3-9 (CF₃O)₃—(PFC)—CONHC₃H₆N⁺(CH₃)₂C₂H₄OH.Cl⁻
3-10 (CF₃O)₂—(PFC)—CONHC₃H₆N⁺(CH₃)₂C₂H₄OH.Cl⁻
3-11 (CF₃O)—(PFC)—CONHC₃H₆N⁺(CH₃)₂C₂H₄OH.Cl⁻
3-12 (CF₃O)₃—(PFC)—CONHC₃H₆N⁺(CH₃)₂H.Cl⁻
3-13 (CF₃O)₂—(PFC)—CONHC₃H₆N⁺(CH₃)₂H.Cl⁻
3-14 (CF₃O)—(PFC)—CONHC₃H₆N⁺(CH₃)₂H.Cl⁻
3-15 [(CF₃O)₃—(PFC)—COOCH₂]₂C(CH₃)N⁺(CH₃)₂H.Cl⁻
3-16 [(CF₃O)₂—(PFC)—COOCH_{2‘]}₂C(CH₃)N⁺(CH₃)₂H.Cl⁻
3-17 [(CF₃O)—(PFC)—COOCH₂]₂C(CH₃)N⁺(CH₃)₂H.Cl⁻
3-18 [(CF₃O)₃—(PFC)—COOCH₂]₂CHC₃H₆N⁺(CH₃)₂H.Cl⁻
3-19 [(CF₃O)₂—(PFC)—COOCH₂]₂CHC₃H₆N⁺(CH₃)₂H.Cl⁻
3-20 {(CF₃O)—(PFC)—COOCH₂]₂CHC₃H₆N⁺(CH₃)₂H.Cl⁻
3-21 (CF₃O)₃—(PFC)—COO(C₂H₄O)₁₂H
3-22 (CF₃O)₂—(PFC)—COO(C₂H₄O)₁₂H
3-23 (CF₃O)—(PFC)—COO(C₂H₄O)₁₂H
3-24 (CF₃O)₃—(PFC)—COO(C₂H₄O)₁₅CH₃
3-25 (CF₃O)₂—(PFC)—COO(C₂H₄O)₁₅CH₃
3-26 (CF₃O)—(PFC)—COO(C₂H₄O)₅CH₃
3-27 [(CF₃O)₃—(PFC)—COOCH₂]₂CHC₃H₆OH
3-28 [(CF₃O)₂—(PFC)—COOCH₂]₂CHC₃H₆OH
3-29 [(CF₃O)—(PFC)—COOCH₂]₂CHC₃H₆OH
3-30 (CF₃O)₃—(PFC)—CONHC₃H₆COONa
3-31 (CF₃O)₂—(PFC)—CONHC₃H₆COONa
3-32 (CF₃O)—(PFC)—CONHC₃H₆COOK
3-33 (CF₃O)₃—(PFC)—CONHC₃H₆SO₃Na
3-34 (CF₃O)₂—(PFC)—CONHC₃H₆SO₃Na
3-35 (CF₃O)—(PFC)—CONHC₃H₆SO₃K
3-36 (CF₃O)₃—(PFC)—CON(C₃H₆SO₃Na)C₃H₇
3-37 (CF₃O)₂—(PFC)—CON(C₃H₆SO₃Na) C₃H₇
3-38 (CF₃O)—(PFC)—CON(C₃H₆SO₃Na)C₃H₇
3-39 {(CF₃O)₃—(PFC)—COOCH₂]₂C(CH₃)COONa
3-40 [(CF₃O)₂—(PFC)—COOCH₂]₂C(CH₃)COONa
3-41 [(CF₃O)—(PFC)—COOCH₂]₂C(CH₃)COONa
3-42 [(CF₃O)₃—(PFC)—COOCH₂]₂C(COONa)₂
3-43 [(CF₃O)₂—(PFC)—COOCH₂]₂C(COONa)₂
3-44 [(CF₃O)—(PFC)—COOCH₂]₂C (COONa)₂
3-45 [(CF₃O)₃—(PFC)—COOCH₂]₂C(CH₃)SO₃Na
3-46 [(CF₃O)₂—(PFC)—COOCH₂]₂C(CH₃)SO₃Na
3-47 [(CF₃O)—(PFC)—COOCH₂]₂C(CH₃)SO₃Na
3-48 [(CF₃O)₃—(PFC)—COOCH₂]₂CHC₃H₆SO₃Na
3-49 [(CF₃O)₂—(PFC)—COOCH₂]₂CHC₃H₆SO₃Na
3-50 [(CF₃O)—(PFC)—COOCH₂]₂CHC₃H₆SO₃Na
   In the foregoing, (PFC) represents a perfluorocyclohexylene group, and when the position of carbonyl group is designated as 1-position, (CF₃O)₃ is substituted at the 3-, 4- or 5-position, (CF₃O)₂ is substituted at the 3- or 4-position and (CF₃O) is substituted at the 4-position.

Synthesis of compounds of formula [3] can be accomplished with reference to JP-A No. 10-158218 and published Japanese translation of PCT international patent application No. 2000-505803.

This invention relates to an actinic ray curing ink-jet ink composition composed of a photo-reactive compound and a colorant. Containing at least one fluorinated surfactant represented by the foregoing formulas [1] to [3] in the ink-jet ink composition overcomes problems that when ejecting the ink from a recording head onto a recording material to perform printing, the diameter of deposited dots becomes larger depending on the kind of recording material or the printing environment, rendering it difficult to perform printing of high precision and high image quality on various recording materials.

In the ink-jet recording method of the invention, the ink composition is deposited onto a recording medium and exposed to an actinic ray to increase the viscosity of the ink. This is anticipated to be concerned with wettability of ink droplets which are ejected from a recording head, deposited onto a recording medium and exposed to an actinic ray to increase the viscosity. Thus, it was proved that the actinic ray curing ink-jet ink containing the fluorinated surfactant of formulas [1] to [3] achieved marked improvements for the foregoing problems, thereby maintaining sufficient wettability onto materials and promoting absorption of a substrate exhibiting absorptivity to achieve increased viscosity by concentration due to absorption.

Various kinds of dyes and pigments known in ink-jet recording can be employed as colorants used for the ink-jet ink of the invention. Colorants usable in the invention are preferably anionic ones in terms of the combination with ionicity of the side chain of an actinic ray crosslinking resin.

Dyes usable in the invention are not specifically limited and include, for example, acid dyes, direct dyes, water-soluble dyes such as reactive dyes and disperse dyes, and anionic dyes are preferable.

Anionic water-soluble dyes usable in the invention include, for example, azo dyes, methine dyes, azomethine dyes, xanthene dyes, quinone dyes, phthalocyanine dyes, triphenylmethane dyes and diphenylmethane dyes. Examples of specific compounds thereof are shown below but are not limited to these.

C.I. Acid Yellow:

1, 3, 11, 17, 18, 19, 23, 25, 36, 38, 40, 42, 44 ,49, 59, 61, 65 ,67, 72, 73, 79, 99, 104, 110, 114, 116, 118, 121, 127, 129, 135, 137, 141, 143, 151, 155, 158, 159, 169, 176, 184, 193, 200, 204, 207, 215, 219, 220, 230, 232, 235, 241, 242, 246;

C.I. Acid Orange:

3, 7, 8, 10, 19, 24, 51, 56, 67, 74, 80, 86, 87, 88, 89, 94, 95, 107 108 116, 122, 127, 140, 142, 144, 149, 152, 156, 162, 166, 168;

C.I. Acid Red:

88, 97, 106, 111, 114, 118, 119, 127, 131, 138, 143, 145, 151, 183, 195, 198, 211, 215, 217, 225, 226, 249, 251, 254, 256, 257, 260, 261, 265, 266, 274, 276, 277, 289, 296, 299, 315, 318, 336, 337, 357, 359, 361, 362, 364, 366, 399, 407, 415;

C.I. Acid Violet:

17, 19, 21, 42, 43, 47, 48, 49, 54, 66, 78, 90, 97, 102, 109, 126;

C.I. Acid Blue:

1, 7, 9, 15, 23, 25, 40, 62, 72, 74, 80, 83, 90, 92, 103, 104, 112, 113, 114, 120, 127, 128, 129, 138, 140, 142, 156, 158, 171, 182, 185, 193, 199, 201, 203, 204, 205, 207, 209, 220, 221, 224, 225, 229, 230, 239, 249, 258, 260, 264, 278, 279, 280, 284, 290, 296, 298, 300, 317, 324, 333, 335, 338, 342, 350;

C.I. Acid Green:

9, 12, 16, 19, 20, 25, 27, 28, 40, 43, 56, 73, 81, 84, 104, 108, 109;

C.I. Acid Brown:

2, 4, 13, 14, 19, 28, 44, 123, 224, 226, 227, 248, 282, 283, 289, 294, 297, 298, 301, 355, 357, 413;

C.I. Acid Black:

1, 2, 3, 24, 26, 31, 50, 52, 58, 60, 63, 107, 109, 112, 119, 132, 140, 155, 172, 187, 188, 194, 207, 222;

C.I. Direct Yellow:

8, 9, 10, 11, 12, 22, 27, 28, 39, 44, 50, 58, 79, 86, 87, 98, 105, 106, 130, 132, 137, 142, 147, 153;

C.I. Direct Orange:

6, 26, 27, 34, 39, 40, 46, 102, 105, 107, 118;

C.I. Direct Red:

2, 4, 9, 23, 24, 31, 54, 62, 69, 79, 80, 81, 83, 84, 89, 95, 212, 224, 225, 226, 227, 239, 242, 243, 254;

C.I. Direct Violet:

9, 35, 51, 66, 94, 95;

C.I. Direct Blue:

1, 15, 71, 76, 77, 78, 80, 86, 87, 90, 98, 106, 108, 160, 168, 189, 192, 193, 199, 200, 201, 202, 203, 218, 225, 229, 237, 244, 248, 251, 270, 273, 274, 290, 291;

C.I. Direct Green:

26, 28, 59, 80, 85;

C.I. Direct Brown:

44, 1.06, 115, 195, 209, 210, 222, 223;

C.I. Direct Black:

17, 19, 22, 32, 51, 62, 108, 112, 113, 117, 118, 132, 146, 154, 159, 169;

C.I. Reactive Yellow:

2, 3, 7, 15, 17, 18, 22, 23, 24, 25, 27, 37, 39, 42, 57, 69, 76, 81, 84, 85, 86, 87, 92, 95, 102, 105, 111, 125, 135, 136, 137, 142, 143, 145, 151, 160, 161, 165, 167, 168, 175, 176;

C.I. Reactive Orange:

1, 4, 5, 7, 11, 12, 13, 15, 16, 20, 30, 35, 56, 64, 67, 69, 70, 72, 74, 82, 84, 86, 87, 91, 92, 93, 95, 107;

C.I. Reactive Red:

2, 3, 5, 8, 11, 21, 22, 23, 24, 28, 29, 31, 33, 35, 43, 45, 49, 55, 56, 58, 65, 66, 78, 83, 84, 106, 111, 112, 113, 114, 116, 120, 123, 124, 128, 130, 136, 141, 147, 158, 159, 171, 174, 180, 183, 184, 187, 190, 193, 194, 195, 198, 218, 220, 222, 223, 228, 235;

C.I. Reactive Violet:

1, 2, 4, 5, 6, 22, 23, 33, 36, 38;

C.I. Reactive Blue:

2, 3, 4, 5, 7, 13, 14, 15, 19, 21, 25, 27, 28, 29, 38, 39, 41, 49, 50, 52, 63, 69, 71, 72, 77, 79, 89, 104, 109, 112, 113, 114, 116, 119, 120, 122, 137, 140, 143, 147, 160, 161, 162, 163, 168, 171, 176, 182, 184, 191, 194, 195, 198, 203, 204, 207, 209, 211, 214, 220, 221, 222, 231, 235, 236;

C.I. Reactive Green:

8, 12, 15, 19, 21;

C.I. Reactive Brown:

2, 7, 9, 10, 11, 17, 18, 19, 21, 23, 31, 37, 43, 46;

C.I. Reactive Black:

5, 8, 13, 14, 31, 34, 39;

C.I. Hood Black:

1 and 2.

Commonly known organic and inorganic pigments can be employed as a pigment usable in the invention, and anionic pigments are preferred. Examples thereof include organic pigments, such as azo pigments, e.g., azo lake, insoluble azo pigments, condensed azo pigments and chelate azo pigments; polycyclic pigments such as phthalocyanine pigments, perylene and perylene pigments, anthraquinone pigments, quinacridone pigments, dioxanedine pigments, thioindigo pigments, isoindolinone pigments, and quinophthalonine pigment; dye lakes such as an acid dye type lake; organic pigments such a nitro pigment, nitroso pigment, aniline black and a daylight fluorescent pigment; and inorganic pigments such as carbon black.

Specific examples of organic pigments are as follows.

Examples of magenta or red pigments include C.I. Pigment Red 2, C.I. Pigment Red 3, C.I. Pigment Red 5, C.I. Pigment Red 6, C.I. Pigment Red 7, C.I. Pigment Red 15, C.I. Pigment Red 16, C.I. Pigment Red 48:1, C.I. Pigment Red 53:1, C.I. Pigment Red 57:1, C.I. Pigment Red 122, C.I. Pigment Red 123, C.I. Pigment Red 139, C.I. Pigment Red 144, C.I. Pigment Red 149, C.I. Pigment Red 166, C.I. Pigment Red 177, C.I. Pigment Red 178 and C.I. Pigment Red 122.

Examples of orange or yellow pigments include C.I. Pigment Orange 31, C.I. Pigment Orange 43, C.I. Pigment Yellow 12, C.I. Pigment Yellow 13, C.I. Pigment Yellow 14, C.I. Pigment Yellow 15, C.I. Pigment Yellow 17, C.I. Pigment Yellow 74, C.I. Pigment Yellow 93, C.I. Pigment Yellow 94, C.I. Pigment Yellow 128 and C.I. Pigment Yellow 138.

Examples of green or cyan pigments include C.I. Pigment Blue 15, C.I. Pigment Blue 15:2, C.I. Pigment Blue 15:3, C.I. Pigment Blue 16, C.I. Pigment Blue 60, and C.I. Pigment Green 7.

To stably disperse pigments described above in the ink, water-soluble resins, as described below are preferably employed as a water-soluble polymer dispersant in terms of ejection stability. Examples of a preferred water-soluble resin include styrene/acrylic acid/alkyl acrylate copolymer, styrene/acrylic acid copolymer, styrene/maleic acid copolymer, styrene/maleic acid/alkyl acrylate copolymer, styrene/methacrylic acid copolymer, styrene/methacrylic acid/alkyl acrylate copolymer, styrene/maleic acid half ester copolymer, vinylnaphthalene/acrylic acid copolymer, and vinylnaphthalene/maleic acid copolymer.

The water-soluble resin content is preferably from 0.1% to 10% by weight of the total amount of an ink, and more preferably 0.3% to 5%.

Water-soluble resins may be used alone or in combination.

Anionic pigments are usable in the invention. In terms of dispersion stability, a pigment, as described above which is dispersed with an anionic polymer dispersant or an anion-modified self-dispersing pigment is preferred as a form of an anionic pigment used in the invention. The anionic polymer dispersant refers to a dispersing agent containing an anionic group which is obtained by neutralizing an acidic group included in the molecule with a basic compound. Examples of such a basic compound include an alkali metal hydroxide such as sodium hydroxide or potassium hydroxide, ammonia and amines such as an alkylamine, and alkanolamine. Amines are specifically preferred in the invention.

Any anionic polymer dispersant having a molecular weight of 1,000 or more is preferably used in the invention. Examples thereof include polyvinyl alcohols; polyvinyl pyrrolidones; acryl resin such as polyacrylic acid, acrylic acid/acryl nitrile copolymer, potassium acrylate/acryl nitrile copolymer, vinyl acetate/acrylic acid ester copolymer and acrylic acid/acrylic acid ester copolymer; styrene-acryl resin styrene-acrylic acid copolymer, styrene/methacrylic acid copolymer, styrene/methacrylic acid/acrylic acid ester copolymer, styrene/a-methylstyrene/acrylic acid copolymer and styrene/a-methylstyrene/acrylic acid/acrylic acid ester copolymer; styrene/maleic acid copolymer, styrene/maleic acid anhydride copolymer; vinylnaphthalene/acrylic acid copolymer, vinylnaphthalene/maleic acid copolymer; vinyl acetate type copolymer and its salt, such as vinyl acetate/ethylene copolymer, vinyl acetate/vinyl carboxylate ethylene copolymer, vinyl acetate/maleic acid ester copolymer, vinyl acetate/crotonic acid copolymer and vinyl acetate/acrylic acid copolymer; and resins containing a homopolymer, copolymer or terpolymer having an acidic functionality of carboxylic acid, sulfonic acid or phosphonic acid. Examples of a monomer providing such an acidic functionality include acrylic acid, methacrylic acid, crotonic acid, maleic acid, maleic acid anhydride, itaconic acid, mesaconic acid, fumaric acid, citraconic acid, vinylacetic acid, acryloxypropionic acid, vinylsulfonic acid, styrenesulfonic acid, 2-acrylamide-2-methylpropanesulfonic acid, allylsulfonic acid, allylphosphonic acid, vinylphosphonic acid and vinylsulfonic acid.

The anion-modified self-dispersing pigment used in the invention, refers to a particulate pigment with an anionic group on the particulate surface and dispersible without a dispersing agent. Thus, the anion-modified self-dispersing pigment is a pigment which is modified by neutralizing an acidic group-modified pigment with a basic compound, rendering the acidic group to be anionic, whereby the anionic self-dispersing pigment is dispersible in water without using a surfactant.

The particulate pigment with an anionic group on the particulate surface refers to pigment particles, the surface of which is directly modified with an acidic group or to an organic compound containing an organic pigment nucleus, to which an acidic group is bonded directly or via a joint.

Examples of an acidic group (also referred to as a polar group) include a sulfonic acid group, a carboxylic acid group, a phosphoric acid group, a boric acid group and a hydroxyl group. Of these groups, a sulfonic acid group and carboxylic acid group are preferred and a sulfonic acid group is more preferred.

Modifying agents for an acidic group include, for example, sulfur atom-containing treatment agents such as sulfuric acid, fuming sulfuric acid, sulfur trioxide, chlorosulfuric acid, fluorosulfuric acid, amidosulfuric acid, sulfonated pyridine salt and sulfamic acid, and calboxylating agents which oxidizes the pigment particle surface to introduce a carboxylic acid group, such as sodium hypochlorite and potassium hypochlorite. Of these, sulfonating agents such as sulfur trioxide, a sulfonated pyridine salt or sulfamic acid and a carboxylating agent are preferred. As a basic compound to neutralize an acidic group are cited an alkali metal hydroxide such as sodium hydroxide or potassium hydroxide, ammonia and amines such as an alkylamine or alkanolamine. Amines are specifically preferred in the invention.

The particulate pigment with a polar group on the particulate surface (i.e., pigment particles having a polar group on the surface of the particles) can be obtained by oxidizing the surface of the pigment particles with an appropriate oxidizing agent to introduce a polar group such as a sulfonic acid group or its salt to at least a part of the particle surface, as described in WO97/48769, JP-A Nos. 10-110129, 11-246807, 11-57458, 11-189739, 11-323232 and 2000-265094. More specifically, carbon black is oxidized by concentrated nitric acid or color pigments are oxidized with sulfamic acid, sulfonated pyridine salt or amidosulfuric acid in sulfolane or N-methyl-2-pyrrolidone. Oxidation proceeds through such a reaction and water-soluble materials are removed by purification, whereby a pigment dispersion is obtained. A sulfonic acid group which was introduced through oxidation onto the particle surface, may optionally be neutralized with a basic compound.

There are further cited a method in which pigment derivatives are allowed to adsorb onto the pigment particle surface through a milling treatment or the like, as described in JP-A Nos. 11-49974, 2000-273383 and 2000-303014, and a method in which a pigment is dissolved together with a pigment derivative in a solvent and allowed to precipitate in a poor solvent, as described in Japanese Patent Application No. 2000-377068, 2001-1495 and 2001-234966.

The polar group may be in the form of being free or a salt, or may combine with a counter ion to form a counter salt. Examples of such a counter ion include inorganic ions (e.g., lithium, sodium, potassium, magnesium, calcium, aluminum, nickel, ammonium) and organic ions (e.g., trimethylammonium, diethylammonium, pyridinium, triethanolammonium), of which monovalent counter ions are preferred.

An aqueous liquid medium is preferably used as a solvent usable in the invention. Such an aqueous liquid medium (or aqueous solvent) is preferably a mixture of water and water-soluble organic solvents.

In the invention, the amount of such solvents is preferably not less than 7% and not more than 55% by weight, based on the total amount of an ink. It was proved by the inventor that curing reaction was efficiently achieved at a solvent amount of not less than 7% by weight, without causing interaction of the fluorinated surfactant with the actinic ray curing polymeric compound of the invention. A solvent amount of more than 55% produced problems after image formation, such as dry of ink being retarded, resulting in deteriorated abrasion resistance.

Examples of a preferable water-soluble organic solvent include alcohols (e.g., methanol, ethanol, propanol, isopropanol, butanol, isobutanol, secondary butanol, tertiary butanol), polyhydric alcohols (e.g., ethylene glycol, diethylene glycol, triethylene glycol, polyethylene glycol, propylene glycol, dipropylene glycol, polypropylene glycol, butylenes glycol, hexane-diol, pentane-diol, glycerin, hexane-triol, thiodiglycol), polyhydric alcohol ethers (e.g., ethylene glycol monomethyl ether, ethylene glycol monoethyl ether, ethylene glycol monobutyl ether, diethylene glycol monomethyl ether, diethylene glycol monoethyl ether, diethylene glycol monobutyl ether, propylene glycol monomethyl ether, propylene glycol monobutyl ether, ethylene glycol monomethyl ether acetate, triethylene glycol monomethyl ether, triethylene glycol monoethyl ether, triethylene glycol monobutyl ether, ethylene glycol monophenyl ether, propylene glycol monophenyl ether), amines )e.g., ethanolamine, diethanolamine, triethanolamine, N-methyldiethanolamine, N-ethyldiethanolamine, morpholine, N-ethylmorpholine, ethylenediamine, diethylenediamine, triethylenetetramine, tetraethylenepentamine, polyethyleneimine, pentamethyldiethylenetriamine, tetramethylpropylenediamine), amides (e.g., formamide, N,N-dimethylformamide, N,N-dimethylacetoamide), heterocycles (e.g., 2-pyrrolidone, N-methyl-2-pyrrolidone, cyclohexylpyrrolidone, 2-oxazolidone, 1,3-dimethyl-2-imidazolidinone) and sulfoxides (e.g., dimethylsulfoxide).

Commonly known additives may also be incorporated. Examples thereof include a brightener, a defoaming agent, a lubricant, an antiseptic agent, a thickening agent, an antistatic agent, a matting agent, a water-soluble polyvalent metal salt, an acid or base, a pH buffering agent, an antioxidant, a surface tension-controlling agent, a specific resistance-controlling agent, an anti-rusting agent and an inorganic pigment.

Recording mediums usable in the invention are not specifically limited and any one capable of being printed is usable. Not only conventional coated or non-coated paper but also non-absorptive plastics and their film are usable in the invention. Examples thereof include, polyethylene terephthalate (PET) film, oriented polystyrene (OPS) film, oriented polypropylene (OPP) film, oriented nylon (ONy) film, polyvinyl chloride (PVC) film and polyethylene (PE) film. Other plastics, such as polycarbonate, acryl resin, ABS, polyacetal, PVA and rubber, metals, wood and glass are also applicable.

The surface energy of the substrate varies depending on material characteristics. Wettability between deposited ink and the recording medium is variable depending on the recording medium. PVC film exhibiting a relatively low surface energy and OPP film containing a large amount of polar ingredients or PET film containing a large amount of dispersing components which exhibit a relatively high surface energy are included as a recording medium. A surface energy of 20 to 55 mN/m is preferred to achieve suitable recording.

The recording medium usable in the invention preferably exhibits a contact angle of not less than 10 degrees (0) and not more than 40 degrees (0) with respect to water.

Further, the recording medium usable in the invention preferably exhibits a water absorption amount of 0.5 to 5 ml/m² at a contact time (or absorption time) of 0.5 sec. The water absorption amount, which represents water absorbability of the recording medium, is determined in accordance with the Bristow's method, as defined in J. TAPPI Paper and Pulp Test method No. 51-87. This method specifies a method for measuring liquid absorbing behavior of paper and board in a short period of time. The relating reference is described in Tappi J, 65 (12) 98 (1982). The measurement is conducted in the manner, as described, for example, in U.S. Pat. No. 6,620,470.

### EXAMPLES

The present invention will be further described with reference to examples but is by no means limited to these examples. In examples, “%” designates percent by weight (or wt %), unless otherwise noted.

### Example 1

Synthesis of Polymer Compound

Polymer Compound 1:

Into a reaction vessel were placed 56 g of glycidyl methacrylate, 48 g of p-hydroxybenzaldehyde, 2 g of pyridine and 1 g of N-nitroso-phenylhydroxylamine ammonium salt and reacted with stirring in a water bath at 80° C. for 8 hrs to obtain p-(3-methacryloxy-2-hydroxypropyloxy)benzaldehyde.

Next, 30 g of saponified polyvinyl acetate exhibiting a polymerization degree of 300 and a saponification degree of 88%, and 15 g of saponified polyvinyl acetate exhibiting a polymerization degree of 500 and a saponification degree of 99% were dispersed in 225 g of deionized water to obtain a solution. Then, to this solution, 4.5 g of phosphoric acid and p-(3-methacryloxy-2-hydroxypropyloxy)benzaldehyde obtained in the foregoing reaction was further added in such an amount that the modification ratio of the side chains to the backbone (PVA) was 3.2 mol % and stirred at 90° C. for 6 hrs. The obtained solution was cooled to room temperature and 30 g of a basic ion-exchange resin was added thereto and stirred for 1 hr. Thereafter, the ion-exchange resin was filtered out and IRGACURE 2959 (produced by Ciba Speciality Chemicals Corp.), as a photopolymerization initiator was added at a ratio of 1.2 g per 100 g of an aqueous 15% solution and then diluted with deionized water to obtain an aqueous 10% polymer compound solution 1.

Polymer compounds 2-20:

Aqueous solutions of 10% polymer compounds 2-20 were prepared similarly to the foregoing polymer compound solution 1, except that the saponification degree of the saponified polyvinyl acetate and the modification degree of the side chains to the backbone were varied as shown in Table 1.

Preparation of Pigment Dispersion

Color pigment dispersions were prepared as follows.

Magenta (M) Pigment Dispersion:

Magenta pigment self-dispersion cabo-jet 260, produced by Cabot Co. was diluted with deionized water to prepare a magenta pigment dispersion having a magenta pigment content of 10%. The average particle size of magenta pigment particles contained in the thus obtained magenta pigment dispersion was 181 nm. The particle size was determined by using Zetasizer 1000 HS (produced by Malvern Corp.).

Black Pigment Dispersion:

Carbon black self-dispersion cabo-jet 300, produced by Cabot Co. was diluted with deionized water to prepare a black pigment dispersion having a carbon black content of 10%. The average particle size of carbon black particles contained in the thus obtained black pigment dispersion was 111 nm. The particle size was determined by using Zetasizer 1000 HS (produced by Malvern Corp.).

Preparation of Ink Set

In each of the examples having a composition shown in Table 1, magenta (M) ink and black ink were prepared using the foregoing magenta pigment dispersion and black pigment dispersion, respectively, and ink sets composed of these magenta and black inks were prepared. In the Table, the respective contents are represented as weight percent. Of surfactants shown in Table 1, Ftergent 100C is an anionic (sodium sulfonated) fluorinated surfactant, Ftergent 150 is an anionic (sodium carboxyrate) fluorinated surfactant, Ftergent 251 is a polyoxyethylene ether fluorinated surfactant and Ftergent 499SW is an amphoteric betaine type fluorinated surfactant (each of which was produced by NEOS Co.), and Novec FC-4430 is a nonionic fluorinated surfactant (produced by 3M corp.).

The respective ink sets were combined with either one of three different sheets of PVC (polyvinyl chloride), PP (polypropylene), PET (polyethylene terephthalate) and coated printing paper, as a recording medium and evaluated as described below.

The contact angle of water on the surface of the respective PVC, PP and PET sheets was measured according to the conventional method. Specifically, immediately after a definite amount (2 μL) of water was dropped onto the recording medium to form a droplet on the surface thereof, the contact angle of the droplet was measured using a contact angle measuring apparatus, DAT 1100 MKII, manufactured by Fibro Co. (Sweden).

With respect to the coated printing paper, the absorption amount of water at a contact time of 0.5 sec. was determined according to the Bristow's method defined in J. TAPPI Paper and Pulp Test Method No. 51-87, employing a Bristow Test Machine Type II (compression type), manufactured

TABLE 1

| | | Pigment | Polymer Compound Dispersion | | | |
|---|---|---|---|---|---|---|
| Example | | Dispersion | Content | Polymerization | Saponification | Modification |
| No. | Surfactant (%) | (%) | (%) | Degree | Degree | Ratio (mol %) |
| 1 | FT-100C*¹ (0.08) | 30 | 20 | 300 | 80 | 3 |
| 2 | FT-251*² (0.20) | 30 | 20 | 200 | 90 | 4 |
| 3 | FT-400SW*³ (0.10) | 30 | 20 | 500 | 80 | 2.5 |
| 4 | FT-150*⁴ (0.02) | 30 | 20 | 500 | 80 | 2 |
| 5 | FT-251 (0.20) | 30 | 20 | 200 | 80 | 4 |
| 6 | FT-100C (2) | 30 | 20 | 1700 | 90 | 1 |
| 7 | FT-400SW (0.20) | 30 | 20 | 300 | 80 | 3 |
| 8 | FT-400SW (0.08) | 30 | 20 | 300 | 90 | 4 |
| 9 | FT-251 (0.10) | 30 | 20 | 500 | 80 | 1.5 |
| 10 | FT-251 (0.20) | 30 | 20 | 300 | 80 | 2.5 |
| 11 | FT-150 (0.20) | 30 | 20 | 300 | 80 | 3.4 |
| 12 | FT-100C (0.10) | 30 | 20 | 300 | 90 | 3 |
| 13 | FC-4430*⁵ (0.08) | 30 | 20 | 500 | 90 | 1.5 |
| 14 | FT-400SW (0.20) | 30 | 20 | 200 | 80 | 3 |
| 15 | FT-150 (0.20) | 30 | 20 | 300 | 80 | 2 |
| 16 | FC-4430 (0.08) | 30 | 20 | 300 | 80 | 2.6 |
| 17 | FC-4430 (0.10) | 30 | 20 | 500 | 99 | 0.5 |
| 18 | SDC*⁶ (1.50) | 30 | 20 | 300 | 77 | 0.8 |
| 19 | SDC(0.80) | 30 | 20 | 1780 | 80 | 0.4 |
| 20 | — | 30 | 20 | 180 | 99 | 4.5 |

| | Organic Solvent | | | | | Recording Medium | | |
|---|---|---|---|---|---|---|---|---|
| | | | Diethylene | | | | Contact | Water |
| | | | glycol | Total | | | Angle | Absorption |
| Example | | Ethylene | monobutyl | Content | Deionized | | of Water | Amount |
| No. | Glycerin | glycol | ether | (%) | Water (%) | Material | (°) | (ml/m²) |
| 1 | 20 | 20 | 8 | 48 | 1.92 | PET*⁷ | 28 | — |
| 2 | 15 | 5 | 8 | 28 | 21.80 | PP*⁸ | 24 | |
| 3 | 15 | 2 | 5 | 22 | 27.90 | PVC*⁹ | 32 | |
| 4 | 5 | — | 3 | 8 | 41.98 | PET | 26 | |
| 5 | 2 | 2 | 1 | 5 | 44.80 | PP | 18 | |
| 6 | 20 | 10 | 14 | 44 | 4.00 | PVC | 5 | |
| 7 | — | 15 | 10 | 25 | 24.80 | CP-1*¹⁰ | | 0.4 |
| 8 | 5 | 10 | 4 | 19 | 30.92 | CP-1 | | 0.4 |
| 9 | 4 | 4 | 3 | 11 | 38.90 | CP-1 | | 0.4 |
| 10 | 2 | 1 | 1 | 4 | 45.80 | CP-1 | | 0.4 |
| 11 | — | 20 | 15 | 35 | 14.80 | CP-2*¹¹ | | 4.8 |
| 12 | 1 | 4 | 1 | 6 | 43.90 | CP-2 | | 4.8 |
| 13 | 15 | 10 | 10 | 35 | 14.92 | CP-2 | | 4.8 |
| 14 | 10 | 20 | — | 30 | 19.80 | CP-3*¹² | | 3 |
| 15 | 10 | 24 | 5 | 39 | 10.80 | CP-3 | | 3 |
| 16 | 15 | 18 | 2 | 35 | 14.92 | CP-3 | | 3 |
| 17 | 5 | 15 | — | 20 | 29.90 | CP-4*¹³ | | 0.6 |
| 18 | 2 | 20 | 3 | 25 | 23.50 | CP-4 | | 0.6 |
| 19 | 30 | 5 | 5 | 40 | 9.20 | CP-4 | | 0.6 |
| 20 | 5 | 1 | — | 6 | 44.00 | PVC | 80 | |

*¹Ftergent 100C,
*²Ftergent 251,
*³Ftergent 400SW,
*⁴Ftergent 150
*⁵Novec FC-4430,
*⁶Sodium dodecylsulfate,
*⁷Polyethylene terephthalate Lumiler (Produced by TORAY),
*⁸Polypropylene YUPO (produced by YUPO Corp.)
*⁹Polyvinyl chloride SIY-110 (produced by Sekisui Kagaku Co., Ltd.)
*¹⁰Coated paper for printing, Tokuryo Art (produced by Mitsubishi Seishi Co., Ltd.)
*¹¹Coated paper for printing, POD Gloss Coat (produced by NEW OJI PAPER)
*¹²Coated paper for printing, OK Top Coat (produced by NEW OJI PAPER)
*¹³Coated paper for printing, SA Kanefuji (produced by NEW OJI PAPER)

Evaluation of Color Bleeding Resistance:

Using a piezo-type head having a nozzle diameter of 25 μm, a driving frequency of 12 kHz, a nozzle number of 128 and a nozzle density of 150 dpi, and an on-demand type ink-jet printer exhibiting a maximum recording density of 1440×720 dpi, a magenta solid image was printed on the respective recording mediums to form a solid magenta background. Further, fine black lines with a 100 μm width were printed on the magenta solid image and visually observed.

The individual ink was continuously ejected and exposed to a 120 W/cm metal halide lamp (MAL 400NL, produced by Nippon Denchi Co., a source power of 3 kW·hr) at 0.1 sec. after deposition.

Evaluation was made with respect to resistance to color bleeding of the line images, based on the following criteria:

A: the boundary between fine lines and the solid background was clear,

B: slight bleeding was observed at boundary areas but presented no problem in quality,

C: bleeding was observed at the boundary areas but was acceptable in quality for practical use,

D: bleeding was apparent at the boundary areas and the line width was increased ca. 1.5 times, causing quality concerns in practical use,

E: the boundary between the fine lines and the solid background was unclear and resistance to bleeding was obviously poor.

In the above, evaluations “D” and “E” were at an unacceptable level as a product.

Glossiness of Solid Image:

A black solid image of 10 cm×10 cm was printed similarly on the respective recording mediums and visually evaluated with respect to naturalness in glossiness of the solid image area on a white background, based on the following criteria:

A: glossiness of the image area was uniform,

B: partial slightly non-uniform glossiness of the image area was observed but was at an acceptable level,

C: slightly non-uniform glossiness was observed in the overall image area but was at an acceptable level,

D: non-uniform glossiness was apparent to the naked eye over the entire image area and was at an unacceptable level,

E: completely non-uniform glossiness of the image area was apparent, due to rising of deposited ink dots and was at an unacceptable level.

In the above, evaluations “D” and “E” were at an unacceptable level as a product.

Glossiness of Line Image on White Background:

Ten black lines of 5 mm×10 cm were printed at intervals of 5 mm on the respective recording mediums and visually evaluated with respect to glossiness of the line images on a white background, based on the following criteria:

A: no difference in glossiness between the lines and the background, and was observed as natural,

B: a slight difference in glossiness between the lines and the background was observed but it was at an acceptable level,

C: a slight difference in glossiness between the lines and the background was observed, and glossiness of the lines was greater than that of the background,

D: a difference in glossiness between the lines and the background was apparent and glossiness of the images was greater than that of the background,

E: a difference in glossiness between the lines and the background was obvious and glossiness of the images was markedly greater than that of the background.

In the above, grades “D” and “E” were at an unacceptable level as a product.

Image Density:

Black solid images were printed on the respective recording mediums, and the density thereof was measured using a reflection densitometer (X-rite, produced by X-Rite Co.), and evaluated based on the following criteria:

A: a black density of not less than 1.5,

B: a black density of less than 1.5 and not less than 1.2,

C: a black density of less than 1.2 and not less than 1.0,

D: a black density of les than 1.0 and not less than 0.8

E: a black density of less than 0.8.

Adhesion Property:

Using a piezo-type head having a nozzle diameter of 25 μm, a driving frequency of 12 kHz, a nozzle number of 128 and a nozzle density of 180 dpi, and an on-demand type ink-jet printer exhibiting a maximum recording density of 1440×720 dpi, a 10 cm×10 cm magenta solid image of the maximum printing density of 720×720 dpi was printed on a coated paper (NK Art Kanefuji N, produced by NEW OJI PAPER.). Thereon, 10×10 squares were cut at intervals of 1 mm by using a cutter. Further, a cellophane adhesive tape (produced by Nichiban Co.) was adhered thereto and released, then, the number of released squares was counted.

The thus obtained results are shown in Table 2.

TABLE 2

| Exam- | Color | Glossiness | Glossiness | | | |
|---|---|---|---|---|---|---|
| ple | Bleeding | of Solid | of Line | | Adhe- | |
| No. | Resistance | Image | Image | Density | sion | Remark |
| 1 | A | A | B | B | 10 | Inv. |
| 2 | A | B | A | B | 10 | Inv. |
| 3 | A | B | A | B | 28 | Inv. |
| 4 | A | A | B | B | 14 | Inv. |
| 5 | B | B | A | B | 12 | Inv. |
| 6 | A | B | B | B | 3 | Inv. |
| 7 | B | B | B | C | 26 | Inv. |
| 8 | C | A | B | A | 15 | Inv. |
| 9 | B | A | B | A | 19 | Inv. |
| 10 | B | A | B | A | 11 | Inv. |
| 11 | A | A | A | A | 8 | Inv. |
| 12 | A | B | B | B | 3 | Inv. |
| 13 | A | A | A | A | 4 | Inv. |
| 14 | A | A | A | A | 6 | Inv. |
| 15 | A | B | A | B | 7 | Inv. |
| 16 | A | A | B | B | 6 | Inv. |
| 17 | A | A | A | A | 9 | Inv. |
| 18 | A | B | A | D | 66 | Comp. |
| 19 | B | A | B | E | 76 | Comp. |
| 20 | C | B | A | E | 89 | Comp. |

As can be seen from Table 2, it was proved that the use of inks of the invention resulted in an improvement in color-bleeding and superior glossiness of images and a white background as well as enhanced density and superior adhesion, leading to enhanced image quality, as compared to comparative examples 18-20.

What is claimed is:

1. An ink-jet ink comprising a colorant, water and a polymeric compound, wherein the polymeric compound is comprised of a hydrophilic backbone having plural side chains and is capable of curing via the side chains upon exposure to an actinic ray, and the ink further comprising a fluorine-containing surfactant represented by the following formulas [1] to [3]:
Rf-(L₁)ₘ-(Y₁)ₙ—X formula [1]
wherein Rf is an aliphatic group containing at least one fluorine atom; L₁ is a divalent linkage group; Y₁ is an alkyleneoxy or alkylene group; X is a hydrogen atom, a hydroxyl group, an anionic group or a cationic group; m is an integer of 0 to 5 and n is an integer of 0 to 40,
Rf-(o-Rf′)ₙ₁-L₂-X′ₘ₁ formula [2]
wherein Rf is an aliphatic group containing at least one fluorine atom; Rf′ is an alkylene group containing at least one fluorine atom; L₂ is a single bond or a linkage group; X′ is a hydroxyl group, an anionic group or a cationic group; n1 and m1 are each an integer of 1 or more,
[(Rf′O)ₙ₂-(PFC)—CO-Y₂]ₖ-L₃-X″ₘ₂ formula [3]
wherein Rf″ is a perfluoroalkyl group having 1 to 4 carbon atoms; (PFC) is a perfluorocycloalkylene group; Y₂ is a linkage group containing an oxygen atom or a nitrogen atom; L₃ is a single bond or a linkage group; X″ is a water-solubilizing polar group containing an anionic group, a cationic group, a nonionic group or an amphoteric group; n2 is an integer of 1 to 5, k is an integer of 1 to 3 and m2 is an integer of 1 to 5 5.

2. The ink-jet ink of claim 1, wherein the polymeric compound is represented by the following formula (A):
Poly-{(X₁)ₘ-[B-(Y₁)ₙ]ₚ} formula (A)
wherein Poly represents the backbone and {(X₁)ₘ-[B-(Y₁)ₙ]ₚ} represents the side chains, in which X₁ is a (p+1)-valent linkage group, p is an integer of 1 to 5, B is a curing group, Y₁ is a hydrogen atom or a substituent, m is 0 or 1 and n is 0 or 1.

3. The ink-jet ink of claim 1, wherein in the polymeric compound, the backbone is a saponified polyvinyl acetate exhibiting a saponification degree of 77% to 99%, a polymerization degree of 200 to 1700 and a modification ratio of the side chains to the backbone of not less than 0.5 mol % and not more than 4 mol %.

4. The ink-jet ink of claim 1, wherein the polymeric compound is contained in an amount of 0.5% to 5.0% by weight of the ink.

5. The ink-jet ink of claim 1, wherein the ink contains a water-soluble organic solvent in an amount of 7% to 55% by weight of the ink.

6. The ink-jet ink of claim 5, wherein the water-soluble organic solvent is selected from the group consisting of alcohols, polyhydric alcohols, polyhydric alcohol ethers, amines, amides, heterocycles and sulfoxides.

7. An ink-jet recording method comprising the steps of:
ejecting droplets of an ink-jet ink as defined in claim 1 from an ink-jet head to deposit the droplets onto a recording medium, and
exposing the recording medium to an actinic ray, followed by drying the exposed recording medium.

8. The method of claim 7, wherein the recording medium exhibits a contact angle of 10 to 40 degrees with respect to water.

9. The method of claim 7, wherein the recording medium exhibits an absorption amount of water of 0.5 to 5 ml/m² at a contact time of 0.5 sec. in a Bristow method defined in J. TAPPI paper and pulp test method No. 51-87.

10. The method of claim 7, wherein the recording medium is exposed to the actinic ray within 0.001 to 1.0 sec. after depositing the droplets.

11. The method of claim 1, wherein the actinic ray is a ultraviolet ray or an electron beam.
